(19) United States
(12) Patent Application Publication
(10) Pub. No.: US 2026/0222286 A1
(43) Pub. Date: Jul. 30, 2026

(54) PRIVATE NETWORK DESIGN AND OPTIMIZATION

(71) Applicant: Dell Products L.P., Round Rock, TX (US)

(72) Inventors: Gwenael Poitau, Montreal (CA); Ibrahim Abu Alhaol, Nepean (CA); Javad Mirzaei, Toronto (CA); Rohit Arora, San Jose, CA (US); Said Tabet, Austin, TX (US)

(21) Appl. No.: 19/039,375

(22) Filed: Jan. 28, 2025

(51) Int. Cl. H04L 41/0806; G06F 16/901

(52) U.S. Cl. CPC H04L 41/0806; G06F 16/9024

(57) ABSTRACT

One example method operates to configure and optimize a private communication network, and includes receiving, by a prompt generator, input comprising a KG (knowledge graph), and/or a base network configuration generated by a first LLM (large language model), using, by the prompt generator, the input to create an initial network design prompt, receiving, by a second LLM, the initial network design prompt, and using, by the second LLM, the initial network design prompt to create a site-specific network configuration, providing the site-specific network configuration to a network orchestrator, and orchestrating, by the network orchestrator, the site-specific network configuration to deployment site.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to private communication networks. More particularly, at least some embodiments relate to systems, hardware, software, computer-readable media, and methods, for design, creation, and use, of private communication networks.

### BACKGROUND

Designing private communication networks, such as radio networks for use by private enterprises is a complex task at least in part because an enterprise may have different structures for its verticals, such as manufacturing and retail, for example. At present however, there are no AI (artificial intelligence) based solutions for the design and creation of private communication networks. This is due in part to the fact that business enterprises typically lack personnel with the requisite skill and expertise to design, implement, and manage private radio networks for the enterprise.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses a graph indicating the development of LLMs (large language models) and their components in recent years.

FIG. 2 discloses aspects of an AFM (agentic foundation model) reference architecture.

FIG. 3 discloses an example schema, comprising a method and architecture, for private network design and optimization, according to one embodiment.

FIG. 4 discloses an example computing entity configured and operable to perform any of the disclosed methods, processes, and operations.

### DETAILED DESCRIPTION OF SOME EXAMPLE EMBODIMENTS

Embodiments disclosed herein generally relate to private communication networks. More particularly, at least some embodiments relate to systems, hardware, software, computer-readable media, and methods, for design, creation, and use, of private communication networks.

One or more embodiments comprise a schema, method, and/or architecture, for implementation, maintenance, and use, of a private communication network. Such methods and architectures may be deployed on-premises at an enterprise site. One or more embodiments may leverage knowledge graphs (KG) that model a network in terms of nodes which represent network entities, and edges that connect the nodes and represent relationships between and among the various entities of the network. As well, one or more embodiments may employ LLMs (large language models) for enabling the configuration and deployment of a network.

A method according to one embodiment may be used to define a site-specific configuration, or architecture, for a private network, and such method may comprise operations including: receiving, by a prompt generator, a knowledge graph and information generated by a first LLM; using the KG and the information to generate an AI (artificial intelligence) prompt for an initial design of a network; and, using, by a second LLM, the prompt and network information received from an enterprise site to generate a refined network design. Either or both of the LLMs may comprise a respective GenAI (generative artificial intelligence) module. The refined network design may be provided to a network orchestrator for orchestration to an enterprise site. As operation of the network proceeds at the enterprise site, site-specific information concerning the operation of the network may be gathered and provided as input to the first LLM for further refinement of the network configuration. In an embodiment, a network designed may be implemented in a digital twin (DT) for evaluation. The DT may or may not run alongside the network at the enterprise site. In this way, information gleaned from the DT can be used to update and optimize the network. As well, potential changes to the network may be evaluated on the DT before deployment to the network.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one embodiment may, using one or more LLMs, configure, build, and/or, optimize, a network based on inputs such as KGs, environmental data, and semantic data. An embodiment may generate, such as based on historical logs and reinforcement learning (RL), a forecast as to network configuration and/or operation changes that may be needed. An embodiment may configure, build, and/or, optimize, a network specific to the needs and requirement of a particular enterprise site. An embodiment may identify, possibly in real time, changes needed to the network based on changing conditions at an enterprise site. Various other advantages of one or more example embodiments will be apparent from this disclosure.

### A. Example context for one or more embodiments

One or more embodiments may apply genAI in the context of telco environments. In this regard, AI/ML (artificial intelligence / machine learning) for wireless communication applications, such as telco networks for example, faces various challenges, particularly in large scale deployments. Such challenges include generalization limitations, such as for new network topologies and conditions, and obtaining proper coordination of multi multi-vendor multi multi-agent solutions.

However, it may be expected that recent progress on GenAI, and LLMs in particular, will open a new era in wireless network optimization by providing unprecedented orchestration and generalization capabilities. In the longer term, GenAI may also help to shape new 6G, and subsequent, paradigms such as semantic communications.

Moreover, the approach to telecom standardization may change, possibly significantly. For example, instead of specifying granular elements of network protocols, new telecom standardization approaches may move instead towards only defining high level concepts, such as slicing for example, and leaving the lower-level granular implementation to GenAI platforms.

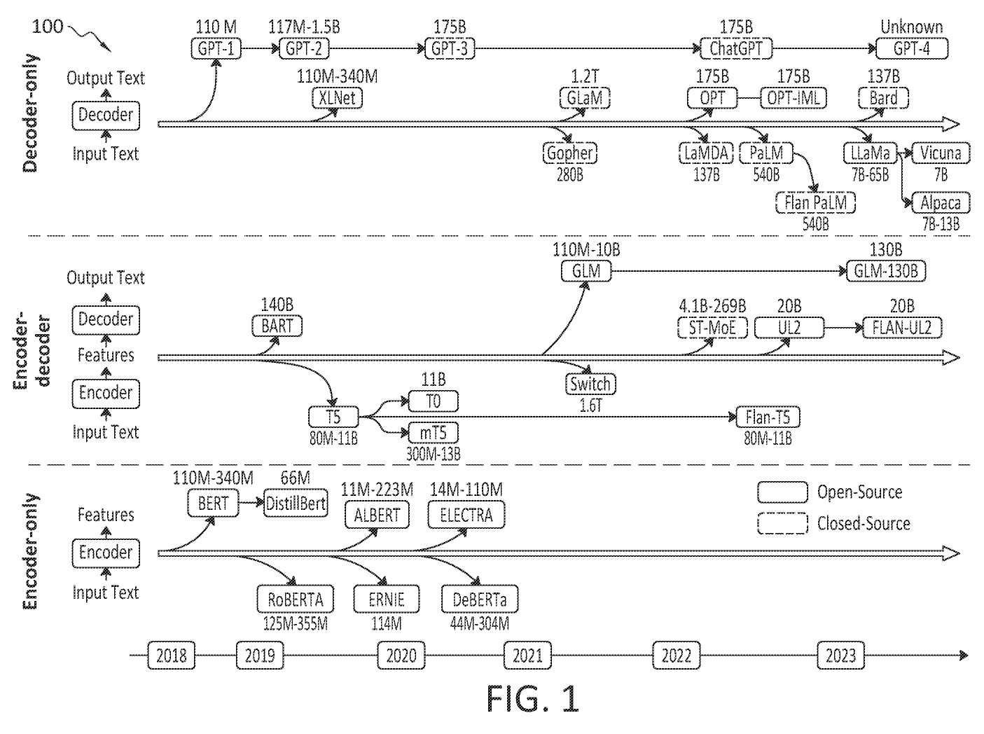

As shown in the example graph 100 disclosed in FIG. 1, the size and architecture of LLMs has progressed significantly between 2018 and 2023. This is particularly true in the areas of encoder-decoder developments, and decoder-only developments. For example, GPT-1 was a key technology in 2018, but has been overtaken by GPT-4 as of 2023. By way of contrast, the pace of development of encoder-only platforms has been somewhat slower than that of the decoder-only platforms, and slower than that of the encoder-decoder platforms.

### B. Introduction – Telco Agentic Foundation Model (AFM)

One or more embodiments may employ an AFM in the context of private network operations. As used herein, a Telco Agentic Foundation Model (AFM) may comprise a GenAI module fine-tuned on telecom data which may includes multiple functions to support its decision decision-making ability including, but not limited to, specialized AI/ML agents, knowledge base, and digital twins. One or more embodiments may employ such a GenAI module for functions including, but not limited to, prompt generation, and network configuration definition and refinement.

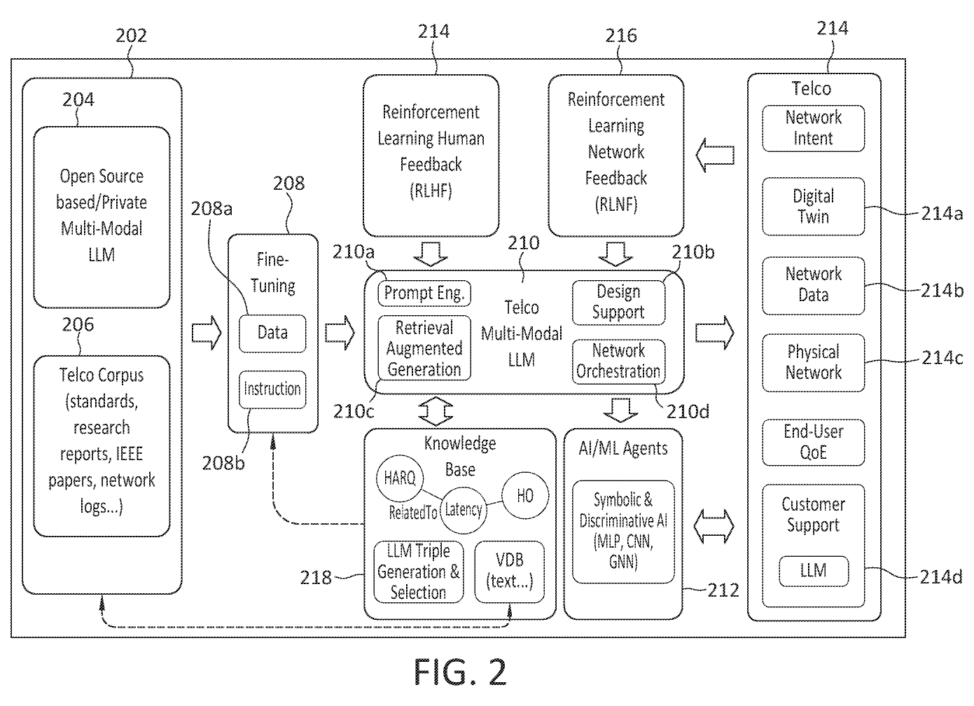

With reference now to FIG. 2, an example AFM reference architecture 200, in which one or more example embodiments may be implemented, is disclosed. This example AFM reference architecture 200 describes various processes and interactions between various components and agents leveraging different knowledge bases, and implementing multiple different LLM instances tuned to achieve specific objectives. Such objectives may include, for example, network operations, network DT and data management, GNN (Graph Neural Network) for network optimization, customer support, and performance evaluation and training.

In more detail, the example architecture 200 may comprise various inputs 202 such as a base-level LLM 204 which may take the form of an open source based/private multi-modal LLM, and various information 206 such as a telco corpus for example. The inputs 202 may be provided to a fine-tuning module 208 that may tune the base-level LLM 204 to create a more specific LLM implementation, such as a telco multi-modal LLM 210. In addition to the inputs 202, the fine-tuning module 208 may also comprise a dataset 208a, and various instructions 208b, which may both be used in a fine tuning process.

The telco multi-modal LLM 210 may operate to define, and orchestrate, such as in cooperation with one or more AI/ML agents 212, one or more elements of a telco network configuration 214. To these, and other, ends, the telco multi-modal LLM 210 may comprise various components, such as prompt engineering 210a, design support 210b, RAG 210c, and a network orchestration module 210d. In connection with its operations, the telco multi-modal LLM 210 may receive various inputs, such as reinforcement learning human feedback 214, and reinforcement learning network feedback 216, both of which may be used by the telco multi-modal LLM 210 to define, implement, and refine, the telco network configuration 214. Further, the reinforcement learning feedback, as well as historical log information concerning usage and configuration of networks, may be used to generate forecasts as to changes to the configuration, and use, of one or more private networks. As well, the telco multi-modal LLM 210 may draw from, and make deposits to, a knowledge base 218, concerning the operations of the telco multi-modal LLM 210.

Finally, the telco network configuration 214 may comprise various elements. Such elements may include, but are not limited to, a digital twin 214a, network data 214b concerning network operations, events, and configurations, a physical communication network 214c, and a customer support module 214d which may comprise, for example, a virtual assistant such as a chatbot that comprises an LLM.

### C. Detailed discussion

### C.1 Introduction

In one or more embodiments, LLMs may be trained on information and inputs such as, but not limited to, (1) historical logs concerning the operations of a network and network entities – examples include computing resources consumed, network bandwidth used, latency within a network, type and number of nodes in a network, (2) data from various sites such as retail sites – examples includes sales types, sales volume, and cost and profit centers of an enterprise, and (3) physical features including manufacturing facility floor plans and equipment types and equipment layouts. Information such as the aforementioned examples may be used in an embodiment to simplify the configuration, deployment, and management, of a private network.

An embodiment may employ other information and inputs as well in the configuration, deployment, and management, of a private network. For example, an embodiment may use KGs (knowledge graphs) that model the entities and relationships in actual, or proposed, network configurations. An embodiment may use site specific details from an actual site, or a prospective site, such as a physical layout, size, and type, of an environment such as, for example, a warehouse, office building, or any other environment where a private network, or portion of one, may be deployed. KGs, site specific details, LLMs, and the various other example information and inputs disclosed may be used in an embodiment to create, orchestrate, and manage, a specific site design architecture.

### C.2 Discussion

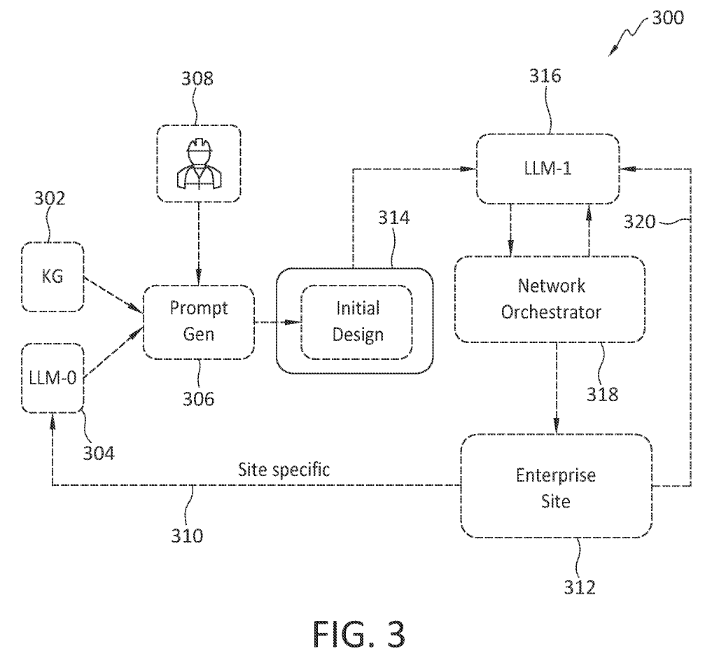

With reference now to FIG. 3, an example schema 300 according to one embodiment is disclosed. The schema 300 may be configured, and used, to configure, deploy, and manage, a new or modified private network, such as a private communications network for example.

As shown in the example of FIG. 3, various inputs may be provided to a prompt generator. In particular, one or more KGs 302 and an LLM 304 may be provided as inputs to a prompt generator 306 which may operate by using those inputs to generate a prompt that may be submitted to an AI model. Such inputs may also comprise human input 308, such as from a user for example. The KG(s) 302 may comprise representations of actual, and/or prospective, network and other similar enterprise specific configurations. The human input 308 may comprise, for example, desired parameters and attributes, and identification of equipment, for a network configuration to be constructed. The LLM 304 may receive semantic data, possibly as part of the human input 308, that comprises information about relationships among entities in an existing, or proposed, network and that includes entity-specific information such as, for example, computing capabilities in terms of memory, storage, latency, bandwidth, number of users, and processing, of one or more entities. The LLM 304 may, in an embodiment, receive site specific information 310 from, and/or concerning, an enterprise site 312 where a new or modified network is to be deployed. The LLM 304 may use the site specific information 310, which may comprise semantic data about the enterprise site 312 and its components and attributes, to generate information concerning an existing, new, or modified, network configuration. The site specific information 310 may comprise information about the structure and operation of an enterprise, such as the verticals, site floor plan, and departments, of the enterprise. In an embodiment, the LLM 304 may generate, as an output, a base network configuration. A site floor plan, for example, may enable evaluation and determination of a best path for radio signal propagation.

The various inputs 302, 304, and/or, 308 may be provided to the prompt generator 306, and may be used by the prompt generator 306 to create an initial network design prompt 314 that may be provided to an LLM 316. More specifically, the LLM 316 may, in response to the initial network design prompt 314, generate, or design, a network configuration. It is noted that the LLM 304 and/or the LLM 316 may be trained, and refined, using various inputs, such as the site specific information 310, and historical logs and site information mentioned above. The network configuration generated by the LLM 316 may be provided by the LLM 316 to a network orchestrator component 318.

The network orchestrator component 318 may then orchestrate the network configuration to the enterprise site 312. In an embodiment, such orchestration may comprise, for example, using the network configuration as a basis for generating a network implementation plan that may be carried out at the enterprise site 312 to build and run a private network. In an embodiment, the network orchestrator component 318 may also identify and implement, or cause the implementation of, changes to the configuration and operation of a network at the enterprise site 312.

With continued reference to FIG. 3, the LLM 316 may also generate designs and configurations for a DT that mimics an anticipated, new, or modified, network. These designs and configuration may, or may not, be implemented as part of an orchestration process performed by the network orchestrator 318.

As shown in FIG. 3, and discussed above, information may be obtained from the enterprise site 312 and provided to the LLM 304, and/or, to the LLM 316. In the first case, the site specific information 310 may be provided to the LLM 304, as discussed earlier herein. The site specific information 310 may comprise, for example, information about the structure and operations of the site itself, as well as information about the structure and operation of any networks running at the enterprise site 312.

Site specific information 320 may also be provided by the enterprise site 312 to the LLM 316. In an embodiment, the site specific information 320 may be similar, or identical, to the site specific information 310. Additionally, or alternatively, the site specific information 320 may comprise information about the structure and operation of a network running at the enterprise site 312, where the network comprises a network configuration generated by the LLM 316 and implemented at the enterprise site 312 by, or at the direction of, for example, the network orchestrator 318. In an embodiment, the site specific information 320 may be provided to the LLM 316 on an ongoing basis, and/or a scheduled basis, and may be used to tune the LLM 316, and possibly generate, by the LLM 316, an updated network configuration for orchestration to the enterprise site 312.

In an embodiment, updated site specific information 320 may be provided to the LLM 316 any time a change occurs that affects the structure or operation of a network, including changes to components of the network, at the enterprise site 312. In an embodiment, the updated site specific information 320 may be provided to the LLM 316 in real time as changes occur in the structure or operation of the network at the enterprise site 312. In an embodiment, information, such as the site specific information 320, about the enterprise site 312 and operation of a network at the enterprise site 312, may be stored in logs that may be accessed when creating a configuration for a new network, and/or when creating a modified configuration for an existing network. In an embodiment, the site specific information 310 may be used only when creating a new network configuration for the enterprise site 312, and the site specific information 320 may be used only when modifying an existing network configuration.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments. These are presented only by way of example and are not intended to limit the scope of this disclosure or the claims in any way.

Embodiment 1. A method for configuring and optimizing a private communication network, comprising: receiving, by a prompt generator, input comprising a KG (knowledge graph), and/or a base network configuration generated by a first LLM (large language model); using, by the prompt generator, the input to create an initial network design prompt; receiving, by a second LLM, the initial network design prompt, and using, by the second LLM, the initial network design prompt to create a site-specific network configuration; providing the site-specific network configuration to a network orchestrator; and, orchestrating, by the network orchestrator, the site-specific network configuration to a deployment site.

Embodiment 2. The method as recited in any preceding embodiment, wherein one or both of the first LLM and the second LLM comprise a respective GenAI (generative artificial intelligence) module.

Embodiment 3. The method as recited in any preceding embodiment, wherein the KG comprises a representation of a network that includes nodes representing network entities, and edges that connect the nodes and represent relationships among the network entities.

Embodiment 4. The method as recited in any preceding embodiment, wherein the base network configuration is generated based in part on site specific information concerning the deployment site.

Embodiment 5. The method as recited in any preceding embodiment, wherein semantic information is provided to the prompt generator and used by the prompt generator as part of creation of the initial network design prompt.

Embodiment 6. The method as recited in any preceding embodiment, wherein the second LLM creates a digital twin that mimics a configuration of a network implemented at the deployment site, and the network implemented at the deployment site is based on the site-specific network configuration.

Embodiment 7. The method as recited in any preceding embodiment, wherein the site-specific network configuration generated by the second LLM is updated in response to a change in a structure, and/or operation, of a network implemented at the deployment site and based on the site-specific network configuration.

Embodiment 8. The method as recited in any preceding embodiment, wherein one or both of the first LLM and the second LLM is trained using information contained in historical logs concerning operation of a network and/or network components.

Embodiment 9. The method as recited in any preceding embodiment, wherein the first LLM is trained using site specific information concerning the deployment site, and the site specific information comprises information about a structure and operation of a business enterprise associated with the deployment site, and further comprises information.

Embodiment 10. The method as recited in any preceding embodiment, wherein information from a digital twin corresponding to the site-specific network configuration is used to update the site-specific network configuration.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

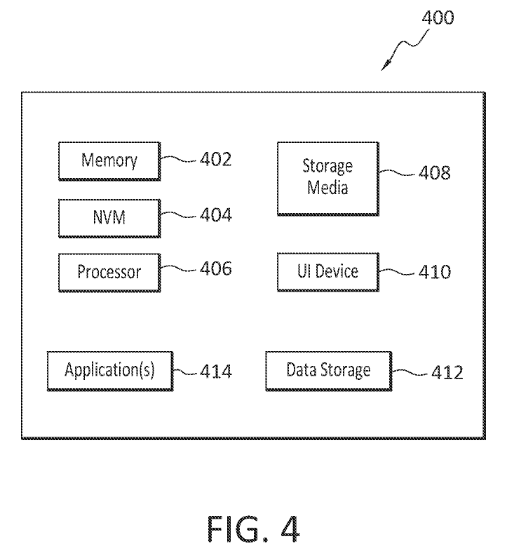

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for configuring and optimizing private communication networks, comprising:
receiving, by a prompt generator, input comprising a KG (knowledge graph), and/or a base network configuration generated by a first LLM (large language model);
using, by the prompt generator, the input to create an initial network design prompt;
receiving, by a second LLM, the initial network design prompt, and using, by the second LLM, the initial network design prompt to create a site-specific network configuration;
providing the site-specific network configuration to a network orchestrator; and
orchestrating, by the network orchestrator, the site-specific network configuration to a deployment site.

2. The method as recited in claim 1, wherein one or both of the first LLM and the second LLM comprise a respective GenAI (generative artificial intelligence) module.

3. The method as recited in claim 1, wherein the KG comprises a representation of a network that includes nodes representing network entities, and edges that connect the nodes and represent relationships among the network entities.

4. The method as recited in claim 1, wherein the base network configuration is generated based in part on site specific information concerning the deployment site.

5. The method as recited in claim 1, wherein semantic information is provided to the prompt generator and used by the prompt generator as part of creation of the initial network design prompt.

6. The method as recited in claim 1, wherein the second LLM creates a digital twin that mimics a configuration of a network implemented at the deployment site, and the network implemented at the deployment site is based on the site-specific network configuration.

7. The method as recited in claim 1, wherein the site-specific network configuration generated by the second LLM is updated in response to a change in a structure, and/or operation, of a network implemented at the deployment site and based on the site-specific network configuration.

8. The method as recited in claim 1, wherein one or both of the first LLM and the second LLM is trained using information contained in historical logs concerning operation of a network and/or network components.

9. The method as recited in claim 1, wherein the first LLM is trained using site specific information concerning the deployment site, and the site specific information comprises information about a structure and operation of a business enterprise associated with the deployment site, and further comprises information.

10. The method as recited in claim 1, wherein information from a digital twin corresponding to the site-specific network configuration is used to update the site-specific network configuration.

11. A non-transitory storage medium having stored therein instructions that are executable by one or more hardware processors to perform operations comprising:
receiving, by a prompt generator, input comprising a KG (knowledge graph), and/or a base network configuration generated by a first LLM (large language model);
using, by the prompt generator, the input to create an initial network design prompt;
receiving, by a second LLM, the initial network design prompt, and using, by the second LLM, the initial network design prompt to create a site-specific network configuration;
providing the site-specific network configuration to a network orchestrator; and
orchestrating, by the network orchestrator, the site-specific network configuration to a deployment site.

12. The non-transitory storage medium as recited in claim 11, wherein one or both of the first LLM and the second LLM comprise a respective GenAI (generative artificial intelligence) module.

13. The non-transitory storage medium as recited in claim 11, wherein the KG comprises a representation of a network that includes nodes representing network entities, and edges that connect the nodes and represent relationships among the network entities.

14. The non-transitory storage medium as recited in claim 11, wherein the base network configuration is generated based in part on site specific information concerning the deployment site.

15. The non-transitory storage medium as recited in claim 11, wherein semantic information is provided to the prompt generator and used by the prompt generator as part of creation of the initial network design prompt.

16. The non-transitory storage medium as recited in claim 11, wherein the second LLM creates a digital twin that mimics a configuration of a network implemented at the deployment site, and the network implemented at the deployment site is based on the site-specific network configuration.

17. The non-transitory storage medium as recited in claim 11, wherein the site-specific network configuration generated by the second LLM is updated in response to a change in a structure, and/or operation, of a network implemented at the deployment site and based on the site-specific network configuration.

18. The non-transitory storage medium as recited in claim 11, wherein one or both of the first LLM and the second LLM is trained using information contained in historical logs concerning operation of a network and/or network components.

19. The non-transitory storage medium as recited in claim 11, wherein the first LLM is trained using site specific information concerning the deployment site, and the site specific information comprises information about a structure and operation of a business enterprise associated with the deployment site, and further comprises information.

20. The non-transitory storage medium as recited in claim 11, wherein information from a digital twin corresponding to the site-specific network configuration is used to update the site-specific network configuration.
